(19) United States
(12) Patent Application Publication
(10) Pub. No.: US 2026/0113126 A1
(43) Pub. Date: Apr. 23, 2026

(54) DISTRIBUTED POWER DIVIDER FOR POWER-OVER-FIBER SYSTEM

(71) Applicant: HUAWEI TECHNOLOGIES CO., LTD., SHENZHEN (CN)

(72) Inventors: Alain VILLENEUVE, Kanata (CA); Eric BERNIER, Kanata (CA); Wen TONG, Kanata (CA)

(73) Assignee: HUAWEI TECHNOLOGIES CO., LTD., SHENZHEN (CN)

(21) Appl. No.: 18/921,695

(22) Filed: Oct. 21, 2024

(51) Int. Cl. H04B 10/80; G02B 6/036; G02B 6/04; G02B 6/122; H02J 50/30; H02J 50/80

(52) U.S. Cl. CPC H04B 10/807; G02B 6/036; G02B 6/04; G02B 6/1228; H02J 50/30; H02J 50/80

(57) ABSTRACT

Methods and systems for delivering power over an optical fiber are provided. In embodiments, light carrying optical power is provided by the optical fiber to a tapered fiber-bundle divider (TFBD), where the light is then divided into branches. In some embodiments, each branch is directed to a respective, further TFBD, where that branch is divided into subsequent branches. Electrical power is generated from each subsequent branch. In some embodiments, the light carries an optical signal, and a signal branch is created by the initial TFBD. In some of these embodiments, a multimode coupler is used to extract optical power from the signal branch. In some embodiments, each branch is matched to an electrical load according to the power generated from that branch and the power requirements of the electrical load. In some embodiments, an all-glass double-clad fiber or a triple-clad fiber is used to provide light.

### CROSS-REFERENCE TO RELATED APPLICATIONS

This is the first application filed for the present invention.

### FIELD OF THE INVENTION

The present application pertains to power systems and in particular to methods and systems for power delivery over optical fibers.

### BACKGROUND

Power-over-fiber (PwoF) systems enable electrical power to be transferred from one location to another through an optical fiber. At a power source, electrical power is converted to light through a light source such as a laser. The light carries optical power and can be conveyed to a destination through an optical fiber. There, the light can be converted back to electrical power through a power converter (PC), or more specifically a photovoltaic power converter (PPC). The electrical power may then be utilized by a load. Unlike electrical power transmission over copper wire, PwoF is resistant to electromagnetic interference and not susceptible to short circuits or corrosion. PwoF systems can be used in communication systems, especially in delivering power to remote antenna units (RAUs) for sixth generation (6G) communication systems. In these applications, the optical fiber may simultaneously convey an optical signal encoding data. In this way the PwoF system can be dual-purposed and negate a need for separate communication lines.

Currently available PwoF systems, however, are often unable to deliver power sufficient for communication systems. PwoF systems are typically capable of delivering from hundreds of milliwatts to a few watts of electrical power and have been shown delivering up to 50 W. Delivering higher powers is not feasible with these systems though. Inadequacies of the optical components such as optical losses can lead to heat build up and temperature increases that can cause damage to the optical components. In addition, the photovoltaic PCs that receive the optical power can be damaged or become inefficient when the incident light exceeds particular intensities. This creates a need to distribute the optical power broadly among many photovoltaic PCs, which currently available systems fail to address. Tapered fiber bundle dividers (TFBDs), which can divide an input optical signal into multiple output signals, have been proposed as a solution. Yet, current systems employing a TFBD inadequately divide the optical power to avoid heat build-up, optical damage, and intolerable losses.

Therefore, there is a need for methods and systems for PwoF delivery that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and systems for PwoF delivery.

A first aspect of the present disclosure is to provide a method for PwoF delivery. The method may comprise receiving, at a primary TFBD, light from a source optical fiber, with the light having associated thereto an optical power. The light may be divided, by the primary TFBD into a plurality of primary branches of light, each primary branch of light having associated thereto a respective primary portion of the optical power. Each primary branch of light may then be divided into a respective plurality of secondary branches of light by a respective secondary TFBD, such that each secondary branch of light has associated thereto a respective secondary portion of the optical power depending from the respective primary portion of the optical power. From each secondary branch of light and in accordance with the respective secondary portion of the optical power, respective electrical power may be generated by a respective one or more PCs of a plurality of PCs. For each secondary branch of light, the respective electrical power may be delivered to one or more respective loads of a plurality of loads.

In some embodiments of the first aspect, the method may further comprise coupling, from the primary TFBD, each primary branch of light into a respective primary optical fiber, and sending each primary branch of light to the respective secondary TFBD by the respective primary optical fiber. In some of these embodiments, coupling, from the primary TFBD, each primary branch of light into the respective primary optical fiber may include coupling, from the primary TFBD, each primary branch of light into a respective all-glass double-clad fiber (DCF) or a respective triple-clad fiber (TCF). In some embodiments, the method may further comprise coupling each secondary branch of light, from the respective secondary TFBD, into a respective secondary optical fiber, and sending each secondary branch of light, by the respective secondary optical fiber, to one respective PC of the plurality of PCs.

In some embodiments of the first aspect, the method may further comprise dividing each secondary branch of light, by a respective tertiary TFBD, into a respective plurality of tertiary branches of light, with each tertiary branch of light having associated thereto a respective tertiary portion of the optical power depending from the respective secondary portion of the optical power. In some of these embodiments, the method may further comprise sending each secondary branch of light, by a respective secondary optical fiber, to the respective tertiary TFBD. In some embodiments, the method may further comprise sending each tertiary branch of light, by a respective tertiary optical fiber, to one respective PC of the one or more PCs respective to the respective secondary branch of light. In some other embodiments, the method may further comprise dividing each tertiary branch of light, by a respective quaternary TFBD, into a respective plurality of quaternary branches of light, with each quaternary branch of light having associated thereto a respective quaternary portion of the optical power depending from the respective tertiary portion of the optical power. In some of these embodiments, the method may further comprise sending each tertiary branch of light, by a respective tertiary optical fiber, to the respective quaternary TFBD. In some embodiments, the method may still further comprise sending each quaternary branch of light, by a respective quaternary optical fiber, to one respective PC of the one or more PCs corresponding to the respective secondary branch of light.

In some embodiments of the first aspect, the light may further have associated thereto an optical signal. In these embodiments, dividing, by the primary TFBD, the light into the plurality of primary branches of light may include dividing, by the primary TFBD, the light into the plurality of primary branches of light and a signal branch of light, with the signal branch of light receiving the optical signal. In some embodiments, the method may further comprise coupling, from the primary TFBD, the signal branch of light into a signal optical fiber, and sending, by the signal optical fiber, the signal branch of light to a signal receiver. In some embodiments, coupling, from the primary TFBD, the signal branch of light into the signal optical fiber may include coupling, from the primary TFBD, the signal branch of light into an all-glass DCF or a TCF. In some embodiments, the signal optical fiber may include a cladding power stripper (CPS) and the signal branch of light may have associated thereto a residual power depending from the optical power of the light. In these embodiments, the method may further comprise removing, by the CPS, the residual power from the signal branch of light. In some embodiments, the method may further comprise: dividing, by a coupler element, the signal branch of light into a signal mode of light and a power mode of light, with the signal mode of light receiving the optical signal and the power mode of light having associated thereto a respective portion of the optical power depending from the respective portion of the signal branch of light; generating, from the power mode of light and in accordance with the respective portion of the optical power of the power mode of light, respective electrical power by a further PC; and detecting, by a receiver device, the optical signal of the signal mode of light.

In some embodiments of the first aspect, delivering, for each secondary branch of light, the respective electrical power to the one or more respective loads of the plurality of loads may include delivering, for at least one secondary branch of light, the respective electrical power to a remote antenna unit.

In some embodiments of the first aspect, receiving, at the primary TFBD, the light from the source optical fiber may include receiving, at the primary TFBD, the light from an all-glass DCF or a TCF.

In some embodiments of the first aspect, delivering, for each secondary branch of light, the respective electrical power to the one or more respective loads of the plurality of loads may include delivering, for each secondary branch of light, the respective electrical power to the one or more respective loads of the plurality of loads in accordance with a respective power demand of the respective load.

A second aspect of the present disclosure is to provide a PwoF system. The system may comprise a primary TFBD, a plurality of secondary TFBDs, and a plurality of sets of PCs. The primary TFBD may have a respective input port configured to receive light having associated thereto an optical power. The primary TFBD may be configured to divide the light into a plurality of primary branches of light each having associated thereto a respective primary portion of the optical power. The primary TFBD may further have a respective plurality of output ports each configured to provide a respective primary branch of light from among the plurality of primary branches of light. Each secondary TFBD may have a respective input port coupled a respective output port of the plurality of output ports of the primary TFBD and may be configured to receive therefrom the respective primary branch of light. Each secondary TFBD may be configured to divide the respective primary branch of light into a respective plurality of secondary branches of light each having associated thereto a respective secondary portion of the optical power depending from the respective primary portion of the optical power. Each secondary TFBD may further have a respective plurality of output ports each configured to provide a respective secondary branch of light from among the plurality of secondary branches of light of the respective secondary TFBD. Each set of PCs may include one or more PCs and may be coupled to one respective output port of one respective secondary TFBD of the plurality of secondary TFBDs. Each PC may be configured to generate, from the respective secondary branch of light of the respective output port of the respective secondary TFBD and in accordance with the respective secondary portion of the optical power, respective electrical power.

In some embodiments of the second aspect, the system may further comprise a plurality of primary optical fibers each coupling the respective input port of a respective secondary TFBD of the plurality of secondary TFBDs to the respective output port of the plurality of output ports of the primary TFBD and configured to transmit therebetween the respective primary branch of light. In some of these embodiments, each primary optical fiber of the plurality of primary optical fibers may be a multimode fiber. In some other embodiments, each primary optical fiber of the plurality of primary optical fibers may be an all-glass DCF or a TCF.

In some embodiments of the second aspect, each PC may be a PPC. In some embodiments, the primary TFBD may be a high-power TFBD and each secondary TFBD of the plurality of secondary TFBDs may be a medium-power TFBD.

In some embodiments of the second aspect, the system may further comprise a source optical fiber coupled to the respective input port of the primary TFBD and configured to provide the light thereto. In some of these embodiments, the source optical fiber may be an all-glass DCF or a TCF.

In some embodiments of the second aspect, the system may further comprise a plurality of secondary optical fibers each coupled to one respective output port of the respective plurality of output ports of one respective secondary TFBD of the plurality of secondary TFBDs and configured to transmit therefrom the respective secondary branch of light. In these embodiments, each set of PCs may be coupled to the one respective output port of the one respective secondary TFBD of the plurality of secondary TFBDs by the secondary optical fiber respective to the one respective output port of the one respective secondary TFBD. In some of these embodiments, each secondary optical fiber of the plurality of secondary optical fibers is a multimode fiber.

In some embodiments of the second aspect, the system may further comprise a plurality of tertiary TFBDs each having a respective input port coupled to one respective output port of the respective plurality of output ports of one respective secondary TFBD and configured to receive therefrom the respective secondary branch of light. Each tertiary TFBD may be configured to divide the respective secondary branch of light into a respective plurality of tertiary branches of light each having associated thereto a respective tertiary portion of the optical power depending from the respective secondary portion of the optical power. Each tertiary TFBD may further have a respective plurality of output ports each configured to provide a respective tertiary branch of light from among the plurality of tertiary branches of light of the respective tertiary TFBD. Each set of PCs may be coupled to the one respective output port of the one respective secondary TFBD of the plurality of secondary TFBDs by a corresponding tertiary TFBD of the plurality of tertiary TFBDs. In some of these embodiments, the system may further comprise a plurality of tertiary optical fibers each coupled to one respective output port of the respective plurality of output ports of one respective tertiary TFBD of the plurality of tertiary TFBDs and configured to transmit therefrom the respective tertiary branch of light. Each set of PCs may be coupled to the one respective output port of the one respective secondary TFBD of the plurality of secondary TFBDs by a corresponding set of tertiary optical fibers from among the plurality of tertiary optical fibers. In some embodiments, the system may still further comprise a plurality of quaternary TFBDs each having a respective input port coupled to one respective output port of the respective plurality of output ports of one respective tertiary TFBD and configured to receive therefrom the respective tertiary branch of light. Each quaternary TFBD may be configured to divide the respective tertiary branch of light into a respective plurality of quaternary branches of light each having associated thereto a respective quaternary portion of the optical power depending from the respective tertiary portion of the optical power. Each quaternary TFBD may further have a respective plurality of output ports each configured to provide a respective quaternary branch of light from among the plurality of quaternary branches of light of the respective quaternary TFBD. Each set of PCs may be further coupled to the one respective output port of the one respective secondary TFBD of the plurality of secondary TFBDs by a corresponding set of quaternary TFBDs from among the plurality of quaternary TFBDs. In some of these embodiments, the system may further comprise a plurality of quaternary optical fibers each coupled to one respective output port of the respective plurality of output ports of one respective quaternary TFBD of the plurality of quaternary TFBDs and configured to transmit therefrom the respective quaternary branch of light. Each set of PCs may be further coupled to the one respective output port of the one respective secondary TFBD of the plurality of secondary TFBDs by a corresponding set of quaternary optical fibers from among the plurality of quaternary optical fibers.

In some embodiments of the second aspect, the light may further have associated thereto an optical signal. In these embodiments, the primary TFBD may be further configured to divide the light into the plurality of primary branches of light and a signal branch of light, the signal branch of light receiving the optical signal. In some embodiments, the primary TFBD may further have a signal port configured to provide the signal branch of light, and the system may further comprise a signal optical fiber coupled to the signal port of the primary TFBD and configured to transmit the signal branch of light. In some embodiments, the primary TFBD may further have a primary TFBD signal port configured to provide the signal branch of light. In these embodiments, the system may further comprise a coupler element having a respective input port coupled to the primary TFBD signal port of the primary TFBD and configured to receive the signal branch of light therefrom. The coupler element may be configured to divide the signal branch of light into a signal mode of light and a power mode of light, with the signal mode of light receiving the optical signal and the power mode of light having associated thereto a respective portion of the optical power depending from the respective portion of the signal branch of light. The coupler element further may have a coupler power output port and a coupler signal output port. The coupler power output port may be configured to provide the power mode of light, and the coupler signal output port may be configured to provide the signal mode of light. In these embodiments, the system may further comprise a further PC coupled to the coupler power output port and configured to receive the power mode of light therefrom, with the further PC being further configured to generate, from the power mode of light and in accordance with the respective portion of the optical power, respective electrical power. In these same embodiments, the system may still further comprise a receiver device coupled to the coupler signal output port and configured to receive the signal mode of light therefrom. In some embodiments, the signal branch of light has associated thereto a residual power depending from the optical power of the light, and the signal optical fiber may include a cladding power stripper configured to remove the residual power from the signal branch of light. In some embodiments, the signal optical fiber may be an all-glass DCF or a TCF.

In some embodiments of the second aspect, each PC of the plurality of sets of PCs may be coupled to a respective one or more loads of a plurality of loads in accordance with a respective power demand of each of the respective one or more loads.

A third aspect of the present disclosure is to provide another method for PwoF delivery. The method may comprise receiving, at a TFBD, light from a source optical fiber, the light having associated thereto an optical power, the source optical fiber being one of an all-glass DCF and a TCF. The light may be divided by the TFBD into a plurality of branches of light, each branch of light having associated thereto a respective portion of the optical power. From each branch of light and in accordance with the respective portion of the optical power, respective electrical power may be generated by one respective PC of a plurality of PCs. For each branch of light, the respective electrical power may be delivered to one or more respective loads of a plurality of loads.

In some embodiments of the third aspect, the method may further comprise coupling, from the TFBD, each branch of light into a respective branch optical fiber, each branch optical fiber being an all-glass DCF or a TCF, and sending each branch of light, by the respective branch optical fiber, to the one respective PC of the plurality of PCs.

In some embodiments of the third aspect, the light further may have associated thereto an optical signal. In these embodiments, the source optical fiber may have a core, a first glass cladding, and a second glass cladding. Receiving, at the primary tapered fiber bundle divider (TFBD), the light from the source optical fiber may include receiving, at the primary TFBD: the optical signal of the light by the core of the source optical fiber, and the optical power of the light by the first glass cladding of the source optical fiber. Dividing, by the TFBD, the light into the plurality of branches of light may include dividing, by the TFBD the light into the plurality of branches of light and a signal branch of light. In some embodiments, the method may further comprise coupling, from the TFBD, the signal branch of light into a signal optical fiber, the signal optical fiber being an all-glass DCF or a TCF.

A fourth aspect of the present disclosure is to provide a PwoF system comprising a source optical fiber, a TFBD, and a plurality of PCs. The source optical fiber may be configured to provide light having associated thereto an optical power, with the source optical fiber being one of an all-glass DCF and a TCF. The TFBD may have a respective input port coupled to the source optical fiber and may be configured to receive the light therefrom. The TFBD may be configured to divide the light into a plurality of branches of light each having associated thereto a respective portion of the optical power. The TFBD may further have a respective plurality of output ports each configured to provide a respective branch of light from among the plurality of branches of light. The plurality of PCs may each be coupled to one respective output port of the TFBD. Each PC may be configured to generate, from the respective branch of light of the respective output port of the TFBD and in accordance with the respective portion of the optical power, respective electrical power.

In some embodiments of the fourth aspect, the system may further comprise a plurality of branch optical fibers each coupled to a respective output port of the plurality of output ports of the TFBD and configured to transmit therefrom the respective branch of light, with each branch optical fiber being an all-glass DCF or a TCF.

In some embodiments of the fourth aspect, the all-glass DCF may include a glass core, a first glass cladding having a low hydroxyl content and a low scattering loss, a second glass cladding having a low refractive index, and a jacket having a high refractive index. In some of these embodiments, the glass core of the all-glass DCF may have one or more dopants selected from the group consisting of Al, P, Ge, and F. In addition, the first glass cladding of the all-glass DCF may be made of a silica glass, the second glass cladding of the all-glass DCF may be made of a fluorosilicate glass, and the jacket of the all-glass DCF is made of an acrylate. In some embodiments, the all-glass DCF may further include a pedestal, and one or more stress rods. In some embodiments, the first glass cladding of the all-glass DCF may have a cross-sectional shape selected from the group consisting of squares, pentagons, hexagons, heptagons, octagons, nonagons, decagons, and circles.

In some embodiments of the fourth aspect, the TCF may include a glass core, a first glass cladding having a low hydroxyl content and a low scattering loss, a second glass cladding having a low refractive index, a third cladding having a further low refractive index, and a jacket having a high refractive index. In some of these embodiments, the glass core of the TCF may have one or more dopants selected from the group consisting of Al, P, Ge, and F. In addition, the first glass cladding of the TCF may be made of a silica glass, the second glass cladding of the TCF is made of a fluorosilicate glass, the third cladding of the TCF is made of a fluoroacrylate or a material having a low refractive index, and the jacket of the TCF is made of an acrylate. In some embodiments, the TCF may further include a pedestal and one or more stress rods. In some embodiments, the first glass cladding of the TCF may have a cross-sectional shape selected from the group consisting of squares, pentagons, hexagons, heptagons, octagons, nonagons, decagons, and circles.

In some embodiments of the fourth aspect, the light may further have associated thereto an optical signal. In these embodiments, the TFBD may be further configured to divide the light into the plurality of branches of light and a signal branch of light, with the signal branch of light receiving the optical signal. In addition, the system may further comprise a signal optical fiber coupled to the signal port of the TFBD and configured to transmit the signal branch of light, with the signal optical fiber being an all-glass DCF or a TCF.

A fifth aspect of the present disclosure is to provide another method for PwoF delivery. The method may comprise receiving, at a TFBD, light from a source optical fiber, with the light having associated thereto an optical power and an optical signal. The light may be divided, by the TFBD, into a plurality of power branches of light and a signal branch of light, with each power branch of light and the signal branch of light having associated thereto a respective portion of the optical power, and with the signal branch of light receiving the optical signal. From each power branch of light and in accordance with the respective portion of the optical power, respective electrical power may be generated by a respective primary PC of a plurality of primary PCs. For the signal branch of light, the following may be performed: dividing, by a coupler element, the signal branch of light into a signal mode of light and a power mode of light, the signal mode of light receiving the optical signal, the power mode of light having associated thereto a respective portion of the optical power depending from the respective portion of the signal branch of light; generating, from the power mode of light and in accordance with the respective portion of the optical power of the power mode of light, respective electrical power by a secondary PC; and detecting, by a receiver device, the optical signal of the signal mode of light. The respective electrical power of each one of the power branches of light and the power mode of light may be delivered to one or more respective loads of a plurality of loads.

In some embodiments of the fifth aspect, the method may further comprise coupling, from the TFBD, the signal branch of light into a first signal branch optical fiber, and sending, by the first signal branch optical fiber, the signal branch of light to the coupler element. In some embodiments, coupling, from the TFBD, the signal branch of light into the first signal branch optical fiber may include coupling, from the TFBD, the signal branch of light into an all-glass DCF or a TCF.

In some embodiments of the first aspect, the method may further comprise coupling, from the TFBD, each power branch of light into a respective power branch optical fiber, and sending each power branch of light, by the respective power branch optical fiber, to the respective primary PC of the plurality of primary PCs. In some embodiments, coupling, from the TFBD, each power branch of light into a respective power branch optical fiber may include coupling, from the TFBD, each power branch of light into a respective all-glass DCF or a TCF.

In some embodiments of the fifth aspect, the method may further comprise coupling, from the coupler element, the signal mode of light into a second signal branch optical fiber, and sending, by the second signal branch optical fiber, the signal mode of light to the receiver device. In some embodiments, the second signal branch optical fiber includes a cladding power stripper and the signal mode of light has associated thereto a residual power depending from the respective portion of the optical power of the signal branch of light. In these embodiments, the method may further comprise removing, by the cladding power stripper, the residual power from the signal mode of light.

In some embodiments of the fifth aspect, receiving, at the TFBD, the light from the source optical fiber may include receiving, at the TFBD, the light from an all-glass DCF or a TCF.

In some embodiments of the fifth aspect, delivering the respective electrical power of each one of the power branches of light and the power mode of light to the one or more respective loads of the plurality of loads may include delivering the respective electrical power of each one of the power branches of light and the power mode of light to the one or more respective loads of the plurality of loads in accordance with a respective power demand of each of the one or more respective loads.

A sixth aspect of the present disclosure is to provide a PwoF system comprising a TFBD, a plurality of primary PCs, a coupler element, a secondary PC, and a receiver device. The TFBD may have a respective input port configured to receive light having associated thereto an optical power. The TFBD may be configured to divide the light into a plurality of power branches of light and a signal branch of light, with each power branch of light and the signal branch of light having associated thereto a respective portion of the optical power, and with the signal branch of light receiving the optical signal. The TFBD may further have a respective plurality of TFBD power output ports and a TFBD signal output port, with each TFBD power output port configured to provide a respective power branch of light from among the plurality of power branches of light, and with the TFBD signal output port configured to provide the signal branch of light. The plurality of primary PCs may each be coupled to one respective TFBD power output port of the TFBD. Each PC may be configured to generate, from the respective branch of light of the respective output port of the TFBD and in accordance with the respective portion of the optical power, respective electrical power. The coupler element may have a respective input port coupled to the TFBD signal output port of the TFBD and may be configured to receive the signal branch of light therefrom. The coupler element may be configured to divide the signal branch of light into a signal mode of light and a power mode of light, with the signal mode of light receiving the optical signal and the power mode of light having associated thereto a respective portion of the optical power depending from the respective portion of the signal branch of light. The coupler element may further have a coupler power output port and a coupler signal output port. The coupler power output port may be configured to provide the power mode of light, and the coupler signal output port may be configured to provide the signal mode of light. The secondary PC may be coupled to the coupler power output port and may be configured to receive the power mode of light therefrom. The secondary PC may be further configured to generate, from the power mode of light and in accordance with the respective portion of the optical power, respective electrical power. The receiver device may be coupled to the coupler signal output port and configured to receive the signal mode of light therefrom.

In some embodiments of the sixth aspect, the system may further comprise a first signal branch optical fiber coupling the respective input port of the coupler element to the TFBD signal output port of the TFBD. In some embodiments, the first signal branch optical fiber may be an all-glass DCF or a TCF.

In some embodiments of the sixth aspect, the system may further comprise a second signal branch optical fiber coupling the coupler signal output port to the receiver device. In some embodiments, the signal mode of light may have associated thereto a residual power depending from the respective portion of the optical power of the signal branch of light. In these embodiments, the second signal branch optical fiber may include a cladding power stripper configured to remove the residual power from the signal mode of light.

In some embodiments of the sixth aspect, the system may further comprise a source optical fiber coupled to the input port of the TFBD and configured to provide the light thereto, with the source optical fiber being an all-glass DCF or a TCF.

In some embodiments of the sixth aspect, each primary PC of the plurality of primary PCs and the secondary PC may be coupled to a respective one or more loads of a plurality of loads in accordance with a respective power demand of each of the respective one or more loads.

A seventh aspect of the present disclosure is to provide another method for PwoF delivery. The method may comprise receiving, at a TFBD, light from a source optical fiber, with the light having associated thereto an optical power. The light may be divided, by the TFBD, into a plurality of branches of light, each branch of light having associated thereto a respective portion of the optical power. From the respective branch of light and in accordance with the respective portion of the optical power, respective electrical power may be generated by a respective power converter (PC) of a plurality of PCs. The respective electrical power may be delivered to a respective load of a plurality of loads in accordance with a respective power demand of the respective load.

In some embodiments of the seventh aspect, the method further comprises coupling, from the TFBD, each branch of light into a respective branch optical fiber, and sending each branch of light, by the respective branch optical fiber, to the respective PC of the plurality of PCs. In some of these embodiments, each PC of the plurality of PCs may have associated thereto a respective optimum power rating and sending each branch of light, by the respective branch optical fiber, to the respective PC of the plurality of PCs may include sending, each branch of light, by the respective branch optical fiber, to the respective PC of the plurality of PCs in accordance with the optimum power rating of the respective PC. In some embodiments, coupling, from the TFBD, each branch of light into the respective branch optical fiber may include coupling, from the TFBD, each branch of light into a respective all-glass DCF or a respective TCF.

In some embodiments of the seventh aspect, receiving, at the TFBD, the light from the source optical fiber may include receiving, at the TFBD, the light from an all-glass DCF or a TCF.

In some embodiments of the seventh aspect, the light may further have associated thereto an optical signal. In these embodiments, dividing, by the TFBD, the light into the plurality of branches of light may include dividing, by the TFBD, the light into the plurality of branches of light and a signal branch of light, with the signal branch of light receiving the optical signal.

An eight aspect of the present disclosure is to provide a PwoF system comprising a TFBD, a plurality of PCs, and a plurality of loads. The TFBD may have an input port configured to receive light having associated thereto an optical power. The TFBD may be configured to divide the light into a plurality of branches of light each having associated thereto a respective portion of the optical power. The TFBD may further have a plurality of output ports each configured to provide a respective branch of light from among the plurality of branches of light. The plurality of PCs may each be coupled to one respective output port of the TFBD. Each PC may be configured to generate, from the respective branch of light of the respective output port of the TFBD and in accordance with the respective portion of the optical power, respective electrical power. The plurality of loads each having associated thereto a respective power demand and configured to receive the respective electrical power of a respective PC of the plurality of PCs in accordance with the respective power demand.

In some embodiments of the eighth aspect, each PC of the plurality of PCs may have associated thereto a respective optimum power rating. In these embodiments, each PC of the plurality of PCs may be coupled to the one respective output port of the TFBD in accordance with the respective optimum power rating.

In some embodiments of the eighth aspect, each output port of the plurality of output ports of the TFBD may have associated thereto a respective output power. In these embodiments, each PC of the plurality of PCs may be coupled to the one respective output port of the TFBD in accordance with the output power of the one respective output port. In some embodiments, each output port of the plurality of output ports of the TFBD may have associated thereto a respective position on the TFBD. In these embodiments, the respective output power of each output port of the plurality of output ports of the TFBD may depend from the respective position on the TFBD.

In some embodiments of the eighth aspect, the system may further comprise a source optical fiber coupled to the input port of the TFBD and configured to provide the light thereto, with the source optical fiber being an all-glass DCF or a TCF.

In some embodiments of the eighth aspect, each PC of the plurality of PCs may be coupled to the one respective output port of the TFBD by a respective branch optical fiber, with each branch optical fiber being an all-glass DCF or a TCF.

In some embodiments of the eighth aspect, the light may further have associated thereto an optical signal. In these embodiments, the TFBD may be further configured to divide the light into the plurality of branches of light and a signal branch of light, with the signal branch of light receiving the optical signal.

Embodiments of the present disclosure may facilitate power delivery by optical fiber. Embodiments may mitigate heating and damage to optical components of a power receiver as well as optical losses in transmission or from the components of the power receiver to enable efficient delivery of high optical powers. Embodiments may enable this by using hierarchies of TFBDs, all-glass DCFs or TCFs, and/or coupling elements. Embodiments may further map power availability to power needs to simplify PwoF systems and minimize losses.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a schematic of an example of a typical PwoF system.

FIG. 2 shows a schematic of an example of a typical PwoF power receiver.

FIG. 3 shows a schematic of an example of a typical PwoF power supplier.

FIG. 4 shows a schematic of a cascaded PwoF power receiver, in accordance with an embodiment of the present disclosure.

FIG. 5 shows a schematic of a PwoF power receiver with a coupler element, in accordance with an embodiment of the present disclosure.

FIG. 6 shows a schematic of a PwoF power receiver with power distribution, in accordance with an embodiment of the present disclosure.

FIG. 7 shows a schematic of a PwoF power receiver, in accordance with an embodiment of the present disclosure.

FIG. 8A shows a cross-sectional schematic of a source optical fiber, in accordance with an embodiment of the present disclosure.

FIG. 8B shows a cross-sectional schematic of a TFBD, in accordance with an embodiment of the present disclosure.

FIG. 8C shows a cross-sectional schematic of a TFBD, in accordance with an embodiment of the present disclosure.

FIG. 8D shows a cross-sectional schematic of a TFBD, in accordance with an embodiment of the present disclosure.

FIG. 9A shows a cross-sectional schematic of an all-glass double-clad fiber, in accordance with an embodiment of the present disclosure.

FIG. 9B shows a plot of refractive index versus cross-sectional position for an all-glass double-clad fiber, in accordance with an embodiment of the present disclosure.

FIG. 9C shows a cross-sectional schematic of a triple-clad fiber, in accordance with an embodiment of the present disclosure.

FIG. 9D shows a plot of refractive index versus cross-sectional position for a triple-clad fiber, in accordance with an embodiment of the present disclosure.

FIG. 10A shows a schematic of a multimode coupler, in accordance with an embodiment of the present disclosure.

FIG. 10B shows a cross-sectional schematic of an input port of a multimode coupler, in accordance with an embodiment of the present disclosure.

FIG. 10C shows a cross-sectional schematic of an output port of a multimode coupler, in accordance with an embodiment of the present disclosure.

FIG. 11 shows a flowchart of a method for PwoF power delivery, in accordance with embodiments of the present disclosure.

It will be noted that throughout the appended drawings, like features are identified by like reference numerals.

### DETAILED DESCRIPTION

Embodiments of the present disclosure are generally directed towards providing methods and systems for power delivery through fiber optics. Embodiments may facilitate high-power delivery without damage or losses to optical components. Embodiments may involve receiving light through an optical fiber at a TFBD. The light may be divided into multiple branches by the TFBD and sent to PCs, where the optical power of the light may be converted to electrical power. In some embodiments, after the light is divided at the TFBD and before it is received by the PCs, each of the branches may be further divided at one or more further TFBDs. This may facilitate further reductions in the optical power received at each PC to prevent damage to the PCs. In some embodiments, one or more all-glass double-clad fibers (DCFs) or triple-clad fibers (TCFs) may be used to carry light to and from the TFBD. Each all-glass DCF or TCF may have a first and second cladding that is made of glass to enable high-power applications. In some embodiments, electrical power generated at each PC may be sent directly to a respective electrical load having demand for the particular amount of electrical power. Each PC may further be optimized for the optical power provided by the branch of light that it receives. In some embodiments, the light may have associated with it an optical signal to convey information between a transmitter and a receiver. The TFBD may divide this optical signal from the light that it receives. The optical signal may carry optical power that would be damaging to components of the receiver. In some embodiments, a coupler element such as a multimode coupler (MMC) or a side coupler (SC) is used to extract at least some of the optical power from the optical signal before directing it to the receiver. The optical power that is extracted may be converted to electrical power at a further PC.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to.

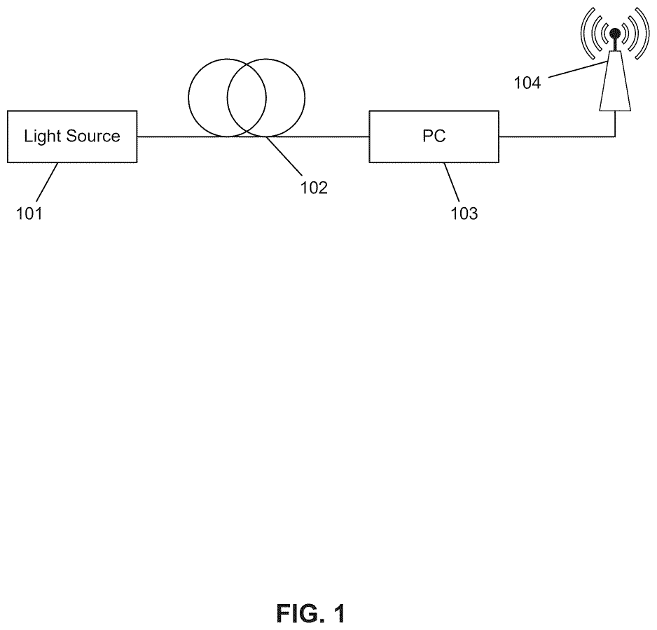

FIG. 1 shows an example of a schematic for a typical PwoF system. The system comprises a light source 101, an optical fiber 102, a PC 103, and a RAU 104. The light source 101 may, for example, be a laser such as a high-power laser. The light source 101 may emit light in the visible, infrared, or ultraviolet regions of the electromagnetic spectrum. For example, the light source 101 may emit light with a wavelength between 790 nm and 980 nm, particularly about 950 nm, or at about 1310 nm or 1550 nm, which are common to fiber optic communication technologies. Light emitted by the light source 101 has associated with it an optical power. The optical fiber 102 receives the light from the light source 102 and transmits it over a distance, which may, for example, span several kilometers. The PC 103 receives the light from the optical fiber 102 and converts, all or a portion of the optical power into electrical power. The PC 103 may, for example, operate as a photovoltaic cell or a thermovoltaic cell. Electrical power generated by the PC 103 is used to power one or more electrical loads, such as the RAU 104.

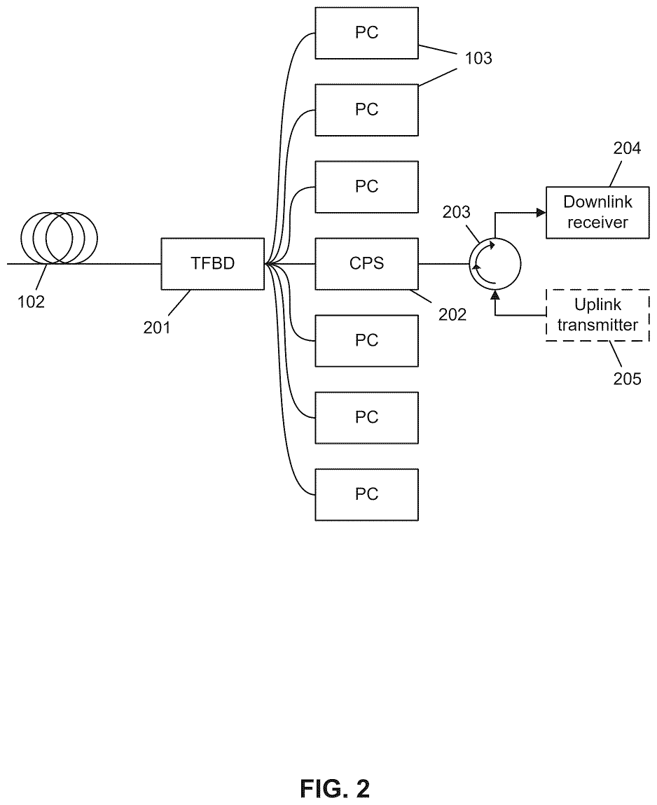

FIG. 2 shows an example of a schematic for a typical PwoF power receiver that includes a TFBD 201 and communications components. Light having optical power associated with it is received by an optical fiber 102 (referred to here as the source optical fiber). The source optical fiber 102 may include a core and cladding such that an optical signal associated with the light is carried by the core and the optical power is primarily carried by the cladding. The optical signal may encode information or data being sent from a data transmitter to a data receiver. An input port of the TFBD 201 is coupled to the source optical fiber 102 to receive the light therefrom. The TFBD 201 divides the received light into a plurality of branches. This may include dividing the light into a plurality of power branches, which carry light from the cladding and each receive a respective portion of the optical power, and into a signal branch, which receives the optical signal from the core of the source optical fiber 102 and may also receive a respective portion of the optical power. Dividing most of the optical power among the power branches may minimize the risk of optical damage to subsequent components of the PwoF power receiver. The TFBD 201 provides light to each power branch and to the signal branch at respective output ports. Each power branch and the signal branch are coupled into respective optical fibers. Each power branch is sent to a respective PC 103, where the respective portion of the optical power (optical signal) is converted to a respective electrical power (electrical signal), which may be used to power one or more loads. The signal branch is sent to a cladding power stripper (CPS) 202 (also referred to as a cladding power suppressor), which may remove optical power from the signal branch to reduce the risk of optical damage to components used to receive the optical signal. The signal branch is then sent to an optical circulator, where the signal branch is directed to a downlink receiver 204. The data is decoded from the optical signal of the signal branch by the downlink receiver 204, such as through the use of a photodetector (e.g., a photodiode), an electrical attenuator, and a signal analyzer. The PwoF power receiver may further include an uplink transmitter 205, which may be coupled to the optical circulator and may be configured to transmit data, such as to a PwoF power supplier. The uplink transmitter 205 may include a laser diode, a polarization controller, an optical modulator (e.g., an electro-optic modulator such as a LiNbO₃ modulator), a signal generator, and an isolator.

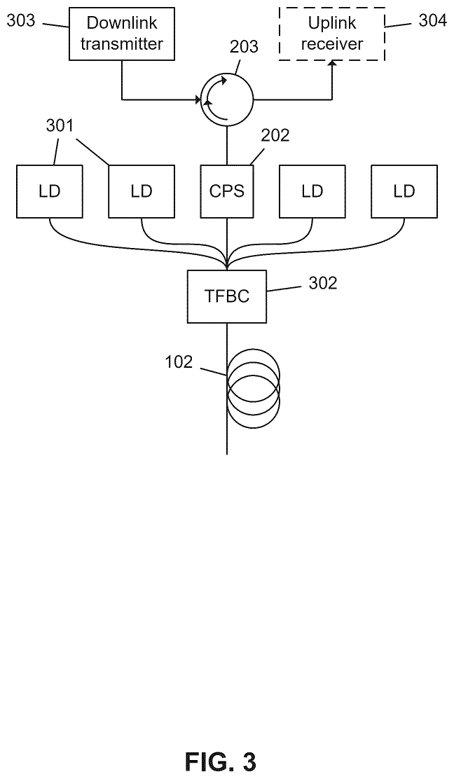

FIG. 3 shows an example of schematic for a typical PwoF power supplier. The PwoF power supplier may be coupled, by an optical fiber 102 to a PwoF power receiver, as described in relation to FIG. 2. Together, the PwoF power supplier and PwoF power receiver may form a PwoF system. The PwoF power supplier includes a plurality of laser diodes (LDs) 301, which may be high-power laser diodes. Each LD 301 emits light having a respective optical power associated with it. The light from each LD 301 is coupled into a respective optical fiber and sent to a respective input port of a tapered fiber bundle combiner (TFBC) 302, which combines the light from each LD 301 and couples it into an optical fiber 102 for delivery to the PwoF power receiver. The light may be coupled into a cladding of the optical fiber 102. The PwoF power supplier further includes a downlink transmitter 303, which generates an optical signal encoding data or information. The downlink transmitter 303 may include an LD, a polarization controller, an optical modulator (e.g., an electro-optic modulator such as a LiNbO₃ modulator), a signal generator, an isolator, a fiber amplifier (e.g., a erbium-doped fiber amplifier), and a bandpass filter. The downlink transmitter 303 is coupled to an optical circulator 203, which directs the optical signal to the TFBC 302. At the TFBC 302 the optical signal is combined with the light from the LDs 301 and may be coupled into a core of the optical fiber 102 for delivery to the PwoF power receiver. The PwoF power supplier may further include an uplink receiver 304 and CPS 202 for receiving optical signals from the PwoF power receiver. The uplink receiver 304 may include a photodetector (e.g., a photodiode), an electrical attenuator, and a signal analyzer.

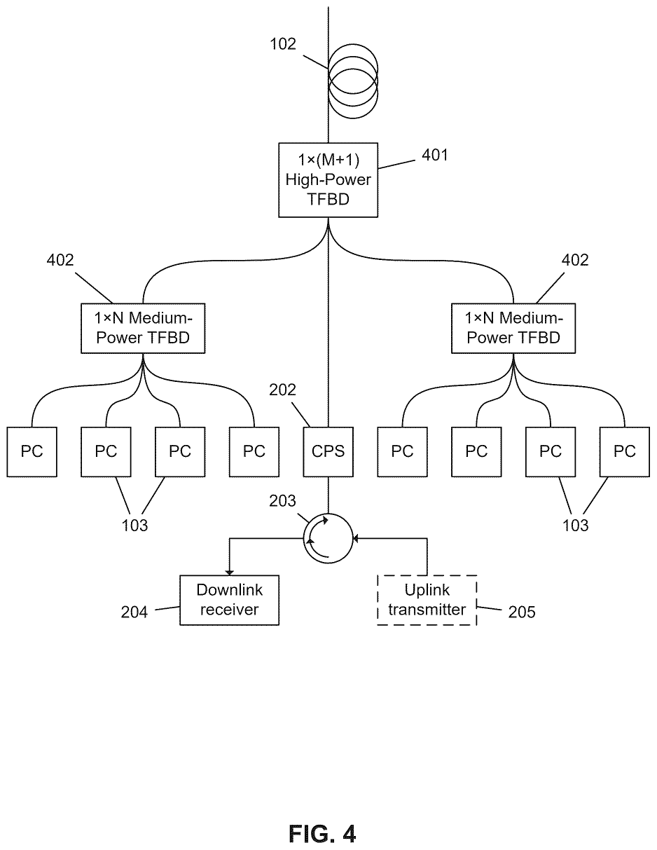

FIG. 4 shows a schematic of a PwoF power receiver, in accordance with an embodiment of the present disclosure. The PwoF power receiver may include a source optical fiber 102 from which light may be received. The source optical fiber 102 may include a core and one or more claddings. The light may have associated with it an optical power and an optical signal. The optical signal may encode data or information. The light may comprise one or more wavelengths, such as from the ultraviolet, visible, and infrared regions of the electromagnetic spectrum. The light may be provided to the optical fiber 102 by a PwoF power supplier, such as the one described in relation to FIG. 3. The PwoF power receiver may include a primary TFBD 401 and a plurality of secondary TFBDs 402. The primary TFBD 401 may have a respective input port configured to receive the light from the source optical fiber 102. The primary TFBD 401 may be configured to divide the light into a plurality of primary branches of light (or power branches of light) and provide each primary branch of light from a respective output port of the primary TFBD 401. Each primary branch of light may receive a respective portion of the optical power of the light. Each respective portion of optical power may be about the same or different. The primary TFBD 401 may further divide the light received from the source optical fiber 102 into a signal branch of light, which may receive the optical signal from the light. The signal branch of light may further have associated with it a respective portion of the optical power of the light. The primary TFBD 401 may be referred to as a 1×(M+1) TFBD, where the first ‘1’ indicates that it has a single input port, ‘M’ indicates the number of output ports for power branches of light, and the second ‘1’ indicates that it has a single output port for the signal branch of light. In some other embodiments, the source optical fiber 102 may have a plurality of cores and may be referred to as a multicore fiber (MCF). In these cases, the light may have a plurality of optical signals associated with it, which may be carried by the plurality of cores of the source optical fiber 102. Alternatively, a portion of the optical power associated with the light may be carried in the additional cores. In some other embodiments, the primary TFBD 401 may be configured to have a first portion of the respective output ports form a first ring of output ports and a second portion of the respective output ports to form a second ring of output ports about the first ring (i.e., concentric rings). For example, a 1×(18+1) primary TFBD 401 could be configured to have a signal output port, a first ring including six output ports, and a second ring including 12 output ports. In these embodiments, the portion of optical power for each primary branch of light corresponding to the first ring of output ports may be about a same first amount, and the portion of optical power for each primary branch of light corresponding to the second ring of output ports may be about a same second amount. The primary TFBD 401 may further be configured to handle high optical powers and so may be referred to as being high-power.

Each primary branch of light provided by the primary TFBD 401 may be coupled into a respective primary optical fiber, such as a multimode fiber, and sent to a respective secondary TFBD 402 of the plurality of secondary TFBDs 402. Each secondary TFBD 402 may have a respective input port configured to receive the respective primary branch of light. Each secondary TFBD 402 may be configured to divide the respective primary branch of light into a respective plurality of secondary branches of light and provide each respective secondary branch of light from a respective output port of that secondary TFBD 402. Each secondary branch of light may receive a respective portion of the optical power of the light depending from the portion of the optical power of the respective primary branch of light. Each secondary branch of light may be coupled into a respective secondary optical fiber, such as a multimode fiber, and sent to a respective PC 103 of a plurality of PCs 103, where the respective portion of the optical power may be converted to respective electrical power. Each PC 103 may, for example, operate as a photovoltaic cell or a thermovoltaic cell. The electrical power generated by the plurality of PCs 103 may be used to power one or more loads. For example, the electrical power corresponding to one secondary branch of light may be sent to power a RAU 104. Each secondary TFBD 402 may be referred to as a 1×N TFBD, where the 1 indicates that it has a single input port and N indicates the number of output ports for secondary branches of light. Each secondary TFBD 402 may further be configured to handle medium optical powers, because the optical power would have been reduced by the primary TFBD 401, and so each secondary TFBD 402 may be referred to as being medium-power. In some other embodiments, the source optical fiber 102 may have a core that is divided by the primary TFBD 401 such that each primary optical fiber has a respective distributary core, which may be subsequently divided by the respective secondary TFBD 402.

The signal branch of light provided by the primary TFBD 401 may be coupled into a signal optical fiber and sent to a signal receiver (i.e., a downlink receiver 204). The signal optical fiber may include a CPS 202 to reduce the optical power associated with the signal branch of light to minimize the risk of optical damage to components of the signal receiver. In other words, the CPS 202 may remove at least some residual power of the signal branch of light. The CPS 202 may be configured to do this by removing optical power from a cladding of the signal optical fiber, while preserving the optical signal carried in a core of the signal optical fiber. The data may be decoded from the optical signal of the signal branch by the downlink receiver 204, such as through the use of a photodetector (e.g., a photodiode), an electrical attenuator, and a signal analyzer. The PwoF power receiver may further include an optical circulator 203 and an uplink transmitter 205, which may enable the PwoF power receiver to transmit data to the PwoF power supplier. The uplink transmitter 205 may include a laser diode, a polarization controller, an optical modulator (e.g., an electro-optic modulator such as a LiNbO₃ modulator), a signal generator, and an isolator. In embodiments where the source optical fiber 102 is a MCF, the signal optical fiber may likewise be a MCF.

The embodiment shown in FIG. 4 may be said to divide the optical power of the light by a cascade or hierarchy of TFBDs. This may enable the optical power of light processed by individual optical components to be below thresholds for damage and losses of the individual optical components. The embodiment of FIG. 4 may be referred to as having an M×N cascade or M×N outputs. Alternatively, in some embodiments, each secondary TFBD 402 may have a respective number of output ports that may be different from other secondary TFBDs 402 of the plurality of secondary TFBDs, such that the cascade may, for example, result in N+O+P+Q+R+S+T outputs. The number of output ports of each TFBD may be selected to meet thresholds for damage or loss. In some embodiments, the cascade or hierarchy of TFBDs may include further divisions and branches. For example, some embodiments may include a plurality of tertiary TFBDs that each receive a respective secondary branch of light and divide it into a respective plurality of tertiary branches of light. These tertiary branches of light may be coupled into respective tertiary optical fibers and sent to a respective PC 103 of a plurality of PCs 103 for power conversion. Some other embodiments may include a plurality of quaternary TFBDs that each receive a respective tertiary branch of light and divide it into a respective plurality of quaternary optical fibers and sent to a respective PC 103 of a plurality of PCs 103 for power conversion. The cascade or hierarchy of TFBDs may not be limited to primary, secondary, tertiary, or quaternary levels of TFBDs.

In some other embodiments, at least one of the source optical fiber 102, the primary optical fibers, and the signal optical fiber may be an all-glass DCF or a TCF. In these embodiments, the PwoF power receiver may only have a primary TFBD 401, and may lack secondary TFBDs 402 or other hierarchical levels of TFBDs. DCF typically include a core, a first cladding, and a second cladding. In this arrangement, the core is typically used to transmit a signal, the first cladding is used to transmit optical power, and the second cladding is used to provide waveguiding by total internal reflection (i.e., the core, the first cladding, and the second cladding have successively lower refractive indices). A jacket is typically added to the fiber to provide mechanical protection. The cladding layers of a DCF are typically made of a fluoroacrylate. Fluorination of acrylate reduces the refractive index to provide a material that can be desirable for cladding. However, fluorination also typically softens acrylates and makes them susceptible to degradation due to environmental factors such as humidity or temperature, or due to high optical power. This degradation can lead to optical losses and fiber failure. In contrast, each all-glass DCF of embodiments of the present disclosure may include a glass core, a first glass cladding, a second glass cladding, and a jacket. The glass core may be single mode or multimode, and may include dopants such as aluminum, phosphorous, germanium, and fluorine. The first glass cladding may be made of a silica glass with, for example, a low-hydroxyl content and low scattering. A low-hydroxyl content and low scattering may be determined according to the consequent attenuation by the fiber. For example, a low-loss fiber, having an attenuation on the order of 1 dB/km may be considered as having a low-hydroxyl content and low scattering. In contrast, a high-loss fiber, having an attenuation in excess of 10 dB/km, may be considered to have a high-hydroxyl content and/or high scattering. The second glass cladding may also be made of a silica glass, but with a refractive index that is lower than that of the first glass cladding. Each of the first glass cladding and the second glass cladding may be fluorinated as a fluorosilicate to provide a low refractive index. The refractive index of each cladding may be selected to provide sufficient waveguiding and to provide a numerical aperture for sufficient in-coupling of light. The jacket may be made of an acrylate with a high refractive index. Each DCF may further include a pedestal to increase the refractive index of the glass core, and one or more stress rods to provide mechanical stability. TCFs may be used as an alternative to all-glass DCFs. These may be configured like all-glass DCFs but may have an additional third cladding between the second glass cladding and the jacket. The third cladding may have a refractive index that is lower than that of the second glass-cladding and may be made of a fluoroacrylate or another material with a low refractive index.

In some other embodiments, the source optical fiber 102 may lack a core for carrying an optical signal. In these cases, the PwoF power receiver may be used only for power delivery instead of power and data delivery. Each output port of the primary TFBD 401 may be configured to provide a primary branch of light (or power branch of light). Thus, the primary TFBD 401 may be configured as a 1×M TFBD. The source optical fiber 102 may still be an all-glass DCF or TCF, except without a glass core.

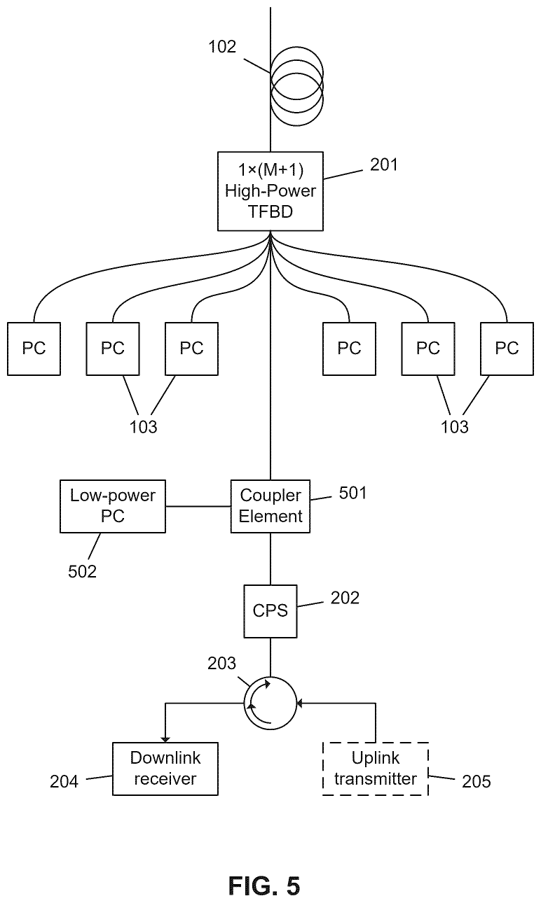

FIG. 5 shows a schematic of a PwoF power receiver, in accordance with another embodiment of the present disclosure. The PwoF power receiver may include a source optical fiber 102 from which light may be received. The source optical fiber 102 may include a core and one or more claddings. The light may have associated with it an optical power and an optical signal. The optical signal may encode data or information. The light may be provided to the optical fiber 102 by a PwoF power supplier, such as the one described in relation to FIG. 3. The PwoF power receiver may include a TFBD 201 with a respective input port configured to receive the light from the source optical fiber 102. The TFBD 201 may be configured to divide the light into a plurality of power branches of light and provide each power branch of light from a respective output port of the TFBD 201. Each power branch of light may receive a respective portion of the optical power of the light. Each respective portion of optical power may be about the same or different. The TFBD 201 may further divide the light received from the source optical fiber 102 into a signal branch of light, which may receive the optical signal from the light. The signal branch of light may further have a respective portion of the optical power of the light. The TFBD 201 may be a 1×(M+1) TFBD, as described above, and may be high-power.

Each power branch of light provided by the TFBD 201 may be coupled into a respective power branch optical fiber, such as a multimode fiber, and sent to a respective PC 103 of a plurality of PCs 103, where the respective portion of the optical power may be converted to respective electrical power. The electrical power generated by the plurality of PCs 103 may be used to power one or more loads.

The signal branch of light provided by the TFBD 201 may be coupled into a signal optical fiber and sent to a signal receiver (i.e., a downlink receiver 204). The PwoF power receiver may further include coupler element 501 such as a MMC or SC (especially a tapered fiber bundle side coupler), to which the signal optical fiber delivers the signal branch of light. The coupler element 501 may have an input port configured to receive the signal branch of light and may be configured to divide the signal branch of light into a signal mode of light and a power mode of light. The power mode of light may have associated with it a portion of the optical power of the light that depends from the respective portion of optical power of the signal branch of light. The signal mode of light may receive the optical signal from the signal branch of light and may have associated with it a residual portion of the optical power of the signal branch of light. Each of the power mode of light and the signal mode of light may be provided by the coupler element 501 at respective output ports (i.e., a coupler power output port and a coupler signal output port).

The power mode of light may be coupled into a respective optical fiber and sent to a respective PC 502, where the respective portion of the optical power may be converted to respective electrical power. The electrical power generated by the PC 502 may be used to power one or more loads. The PC 502 may be considered a low-power PC 103, as the optical power of the power mode of light may be expected to be typically weak. The PC 502 may increase the efficiency of the PwoF power receiver by enabling at least some of the optical power of the signal branch of light to be harvest rather than mostly removed and dispersed by a CPS 202.

The signal mode of light may be coupled into a respective fiber optical fiber and sent to the signal receiver. That optical fiber may include a CPS 202 to reduce residual optical power associated with the signal mode of light to minimize the risk of optical damage to components of the signal receiver. In other words, the CPS 202 may remove at least some residual power of the signal branch of light. The data may be decoded from the optical signal of the signal mode of light by the downlink receiver 204, such as through the use of a photodetector, an electrical attenuator, and a signal analyzer. The PwoF power receiver may further include an optical circulator 203 and an uplink transmitter 205, which may enable the PwoF power receiver to transmit data to the PwoF power supplier. The uplink transmitter 205 may include a laser diode, a polarization controller, an optical modulator, a signal generator, and an isolator.

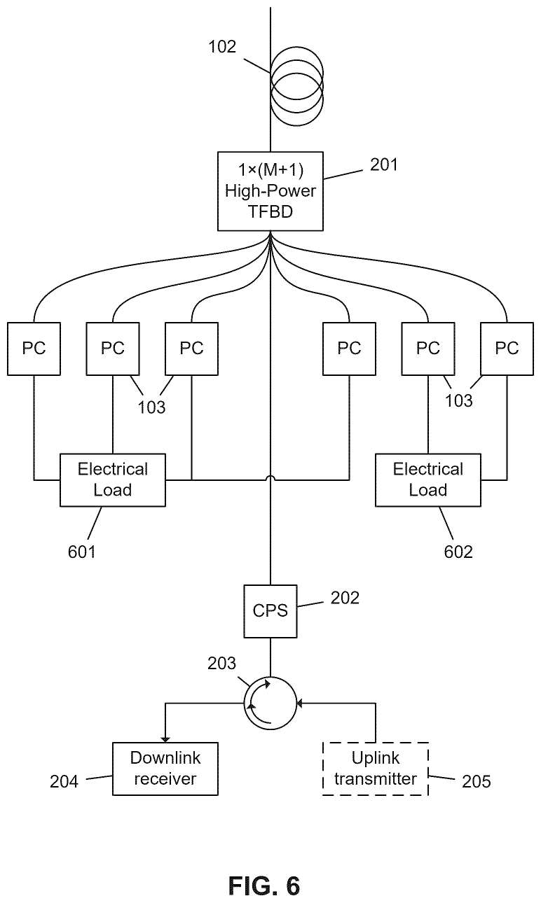

FIG. 6 shows a schematic of a PwoF power receiver, according to another embodiment of the present disclosure. The PwoF power receiver may include a source optical fiber 102 from which light may be received. The source optical fiber 102 may include a core and one or more claddings. The light may have associated with it an optical power and an optical signal. The optical signal may encode data or information. The light may be provided to the optical fiber 102 by a PwoF power supplier, such as the one described in relation to FIG. 3. The PwoF power receiver may include a TFBD 201 with a respective input port configured to receive the light from the source optical fiber 102. The TFBD 201 may be configured to divide the light into a plurality of power branches of light and provide each power branch of light from a respective output port of the TFBD 201. Each power branch of light may receive a respective portion of the optical power of the light. Each respective portion of optical power may be about the same or different. The TFBD 201 may further divide the light received from the source optical fiber 102 into a signal branch of light, which may receive the optical signal from the light. The signal branch of light may further have a respective portion of the optical power of the light. The TFBD 201 may be a 1×(M+1) TFBD, as described above, and may be high-power.

Each power branch of light provided by the TFBD 201 may be coupled into a respective power branch optical fiber, such as a multimode fiber, and sent to a respective PC 103 of a plurality of PCs 103, where the respective portion of the optical power may be converted to respective electrical power. The electrical power generated by the plurality of PCs 103 may be used to power one or more loads. This may be done in accordance with a respective need for power at each of the loads (i.e., a respective power demand), and with the respective electrical power generated by each PC 103. In other words, the PwoF power receiver may distribute electrical power on a point-of-load basis, in contrast with a typical PwoF system where point-of-load converters may be used to adjust the electrical power delivered to loads. For example, a load may have a requirement for a particular electrical power, voltage, or current; one or more PCs 103 may be matched to that load according to the electrical power generated by those PCs 103. One or more electrical loads may further be matched to a set of PCs 103 to meet the load's power demand. FIG. 6 shows two electrical loads (i.e., electrical load 601 and electrical load 602) that are each supplied electrical power from a set of different PCs 103. The electrical power generated by each PC 103 may depend, for example, on losses in the optical components that precede that PC 103 in the PwoF power receiver. Each output port of a TFBD 201 may further provide a different portion of the optical power that is provided to the TFBD 201, and so each PC 103 may receive a different irradiance. For example, the position of a output port on a TFBD may determine the portion of optical power the branch of light provided by that output port. For a TFBD having output ports arranged in concentric rings, as described in relation to FIG. 4, the portion of optical power associated with an output port of the TFBD may depend on the location of that output port in the arrangement of concentric rings.

The signal branch of light provided by the TFBD 201 may be coupled into a signal optical fiber and sent to a signal receiver (i.e., a downlink receiver 204), as described in relation to other embodiments above.

In some other embodiments, each PC 103 may be optimized to match the respective electrical demand of a particular electrical load or the optical power delivered by a particular branch of a TFBD 201. Alternatively, each PC 103 may be coupled to a branch provided by the TFBD 201 according to the an optimum power rating for that PC 103.

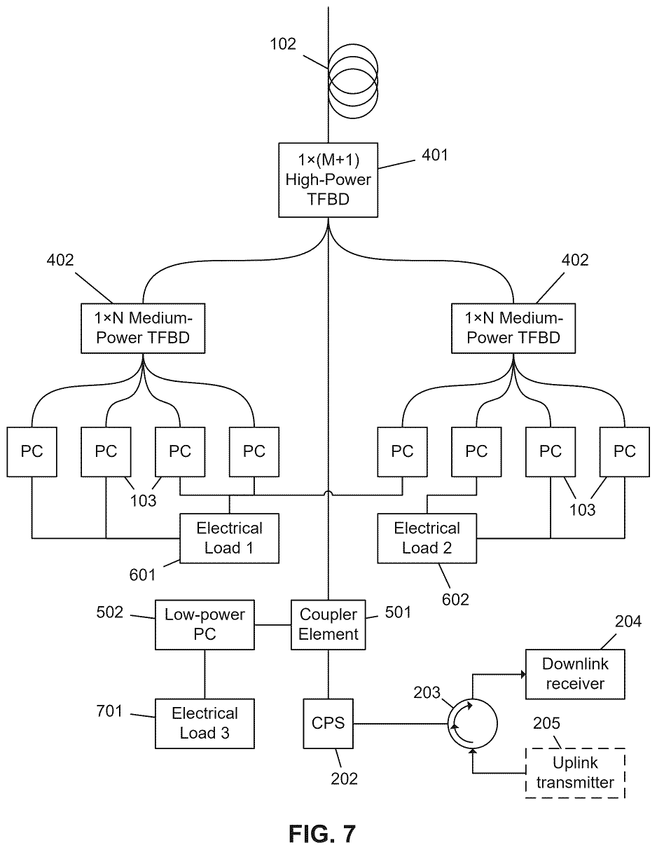

FIG. 7 shows a schematic of a PwoF power receiver, according to another embodiment of the present disclosure. The PwoF power receiver combines a hierarchy of a primary TFBD 401 and secondary TFBDs 402, as described in relation to FIG. 4, a coupler element 501 and low-power PC 502, as described in relation to FIG. 5, and point-of-load power distribution to a plurality of electrical loads (i.e., electrical loads 601, 602 and 701), as described in relation to FIG. 6. The PwoF power receiver may further include one or more all-glass DCFs or TCFs as a source optical fiber 102 or branch optical fibers.

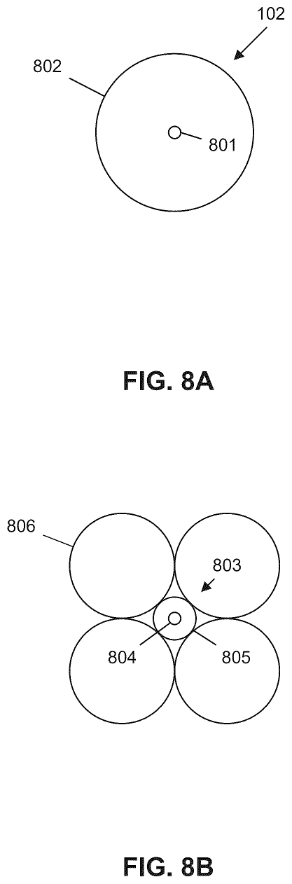

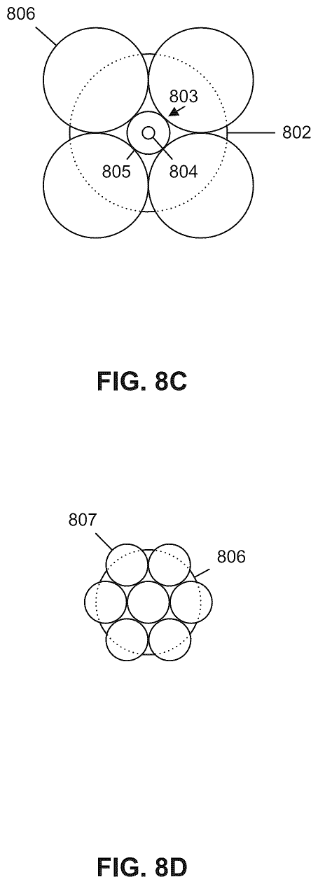

FIG. 8A shows a cross-sectional schematic for a source optical fiber 102, in accordance with an embodiment of the present disclosure. The source optical fiber 102 comprises a core 801 and a cladding 802. The core 801 may be configured to transmit an optical signal, and the cladding 802 may be configured to transmit optical power. In some other embodiments, the source optical fiber 102 may be configured as an all-glass DCF wherein the cladding 802 is a first glass cladding and a second glass cladding encompasses the cladding 802. In some other embodiments, the source optical fiber 102 may be configured as a TFC and may be similarly configured as an all-glass DCF but with a third cladding, as described previously.

FIG. 8B shows a cross-sectional schematic for a TFBD 202, in accordance with an embodiment of the present disclosure. The cross-sectional schematic depicts the optical fibers that may be coupled to output ports of the TFBD 202. Here, a signal branch optical fiber 803 is positioned at the center and may be configured to transmit a signal branch of light from the TFBD 202. The signal branch optical fiber 803 includes a core 804 and a cladding 805. The diameter of the signal optical fiber 803 may, for example, be 80 μm. Four power branch optical fibers 806 are shown positioned peripherally about the signal branch optical fiber 803 and may be configured to transmit a power branch of light from the TFBD 202. Each power branch optical fiber 806 may, for example, be a multimode fiber and have a diameter of about 200 μm. Alternatively, each of the signal branch optical fiber and/or the power branch optical fibers 806 may be configured as an all-glass DCF or TCF. The TFBD 202 shown in FIG. 8B may be a high-power TFBD 401 and may be implemented in the PwoF power receiver described in relation to FIG. 4.

FIG. 8C shows a cross-sectional schematic for a TFBD 202, in accordance with an embodiment of the present disclosure. Here, the source optical fiber 102 as shown in FIG. 8A is superimposed over the signal branch optical fiber 803 and power branch optical fibers as shown in FIG. 8B to depict their overlap.

FIG. 8D shows a cross-sectional schematic for another TFBD 202, in accordance with an embodiment of the present disclosure. The TFBD 202 shown in FIG. 8D may be a medium-power TFBD 402 and may be implemented in the PwoF power receiver described in relation to FIG. 4. A plurality of secondary branch optical fibers 807 are shown superimposed over a primary branch optical fiber 806. The primary branch optical fiber 806 may be coupled to the input port of the TFBD 202 and may be configured to provide thereto a primary branch of light. Each secondary branch optical fiber 807 may be coupled to a respective output port of the TFBD 202 and may be configured to transmit therefrom a respective secondary branch of light. Each secondary branch optical fiber 807 may be a multimode fiber.

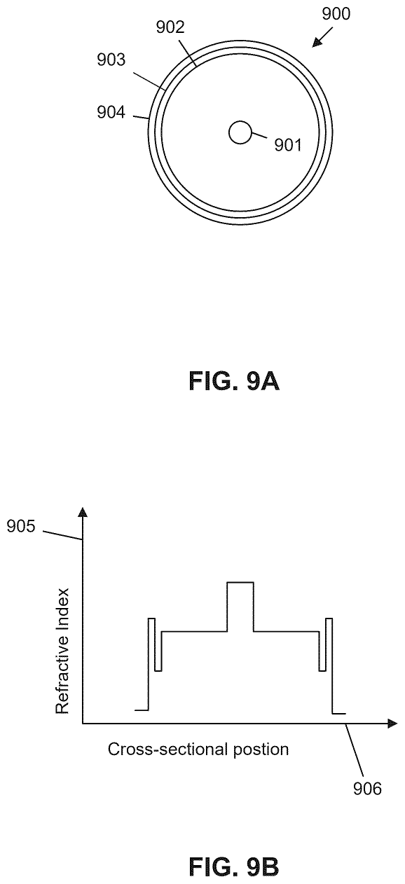

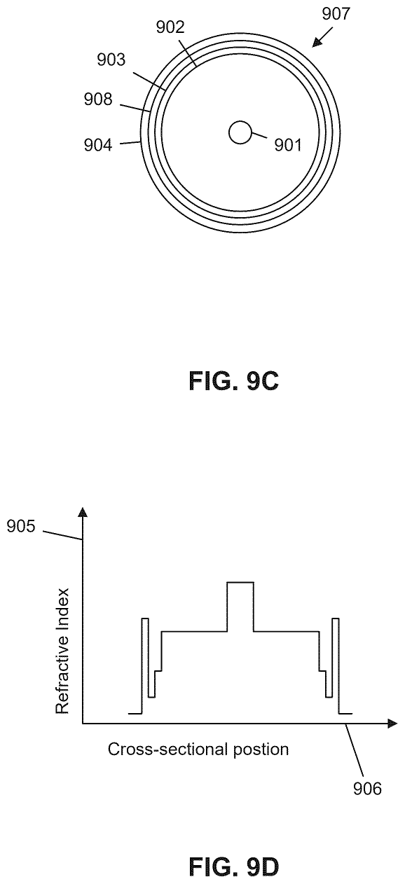

FIG. 9A shows a cross-sectional schematic for an all-glass DCF 900, in accordance with an embodiment of the present disclosure. The all-glass DCF 900 comprises a glass core 901, a first glass cladding 902, a second glass cladding 903, and a jacket 904. The glass core 901 may be single mode or multimode, and may include dopants such as aluminum, phosphorous, germanium, and fluorine. The glass core 901 may have a diameter selected to ensure that the V number for the fiber, which depends on the diameter and the numerical aperture (NA) of the glass core 901, is below the single-mode cut-off. For example, the diameter may be between 5 μm and 25 μm for a NA between about 0.15 and 0.06. The first glass cladding 902 may be made of a silica glass with, for example, a low-hydroxyl content and low scattering. The first glass cladding 902 may, for example, have a diameter of about 400 μm. The second glass cladding 903 may also be made of a silica glass, but with a refractive index that is lower than that of the first glass cladding. The second glass cladding 903 may, for example, have a diameter of about 440 μm. The outer diameter of the all-glass DCF 900 may typically be comprised between about 80 μm and 1000 μm. Each of the first glass cladding 902 and the second glass 903 cladding may be fluorinated as a fluorosilicate to provide a low refractive index. The refractive index of each cladding may be selected to provide sufficient waveguiding and to provide a numerical aperture for sufficient in-coupling of light. The jacket 904 may be made of an acrylate with a high refractive index. In FIG. 9A, the first glass cladding 902 and the second glass cladding 903 are shown with a circular cross section. In some other embodiments, the first glass cladding 902 and/or the second glass cladding 903 may have a cross-sectional shape corresponding to a square, pentagon, hexagon, heptagon, octagon, nonagon, decagon or other polygon. In comparison to circular cross-sections, non-circular cross-sections may facilitate denser packing and stacking of fibers and may disrupt whispering gallery modes.

FIG. 9B shows a plot of refractive index 905 versus cross-sectional position 906 for the all-glass DCF 900 shown in FIG. 9A. Cross-sectional position is measured across a center of the all-glass DCF 900. The plot shows the sequential changes in refractive index across the layers of the all-glass DCF 900. Exterior to the all-glass DCF 900 may be air. The refractive index may then increase for the jacket 904, decrease for the second glass cladding 903, increase for the first glass cladding 902, and increase further for the glass core 901, at the center of the all-glass DCF 900. The jacket 904 may have a high refractive index because it may typically be made of a mechanically robust material such as acrylate, Teflon, or polyimide, which typically have high refractive indices.

FIG. 9C shows a cross-sectional schematic for a TCF 907, in accordance with an embodiment of the present disclosure. The TCF 907 comprises a glass core 901, a first glass cladding 902, a second glass cladding 903, a third cladding 908, and a jacket 904. The glass core 901 may be single mode or multimode, and may include dopants such as aluminum, phosphorous, germanium, and fluorine. The glass core 901 may have a diameter selected to ensure that the V number for the fiber is below the single-mode cut-off. For example, the diameter may be between 5 μm and 25 μm for a NA between about 0.15 and 0.06. The first glass cladding 902 may be made of a silica glass with, for example, a low-hydroxyl content and low scattering. The first glass cladding 902 may, for example, have a diameter of 400 μm. The second glass cladding 903 may also be made of a silica glass, but with a refractive index that is lower than that of the first glass cladding. The second glass cladding 903 may, for example, have a diameter of about 440 μm. The outer diameter of the all-glass DCF 900 may typically be comprised between about 80 μm and 1000 μm. Each of the first glass cladding 902 and the second glass 903 cladding may be fluorinated as a fluorosilicate to provide a low refractive index. The refractive index of each cladding may be selected to provide sufficient waveguiding and to provide a numerical aperture for sufficient in-coupling of light. The third cladding 908 may be made of a fluoroacrylate and may have a diameter of about 480 μm. The jacket 904 may be made of an acrylate with a high refractive index. In FIG. 9C, the first glass cladding 902, the second glass cladding 903, and the third cladding 908 are shown with a circular cross section. In some other embodiments, the first glass cladding 902, the second glass cladding 903, and/or the third cladding 908 may have a cross-sectional shape corresponding to a square, pentagon, hexagon, heptagon, octagon, nonagon, decagon or other polygon.

FIG. 9D shows a plot of refractive index 905 versus cross-sectional position 906 for the TCF 907 shown in FIG. 9C. Cross-sectional position is measured across a center of the TCF 900. The plot shows the sequential changes in refractive index across the layers of the TCF 907. Exterior to the TCF 900 may be air. The refractive index may then increase for the jacket 904, decrease for the third cladding 908, increase for the second glass cladding 903, further increase for the first glass cladding 902, and still further increase for the glass core 901, at the center of the TCF 907. The jacket 904 may have a high refractive index because it may typically be made of a mechanically robust material such as acrylate, Teflon, or polyimide, which typically have high refractive indices.

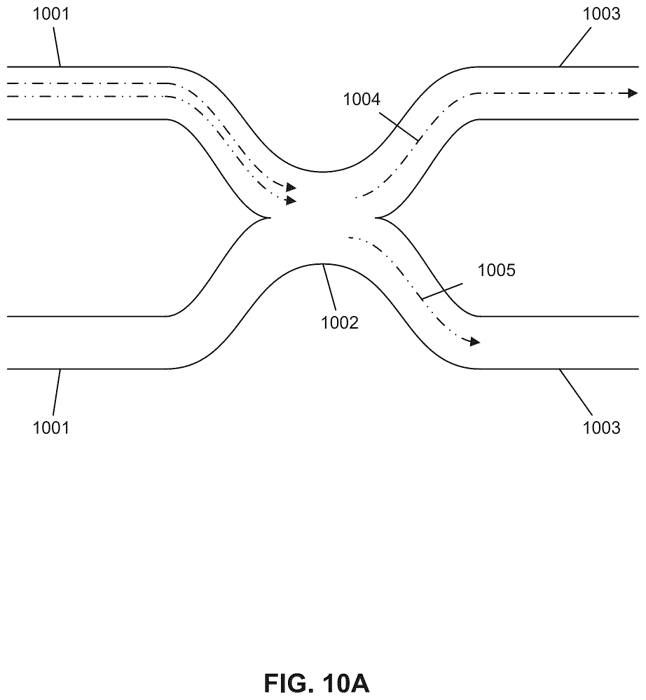

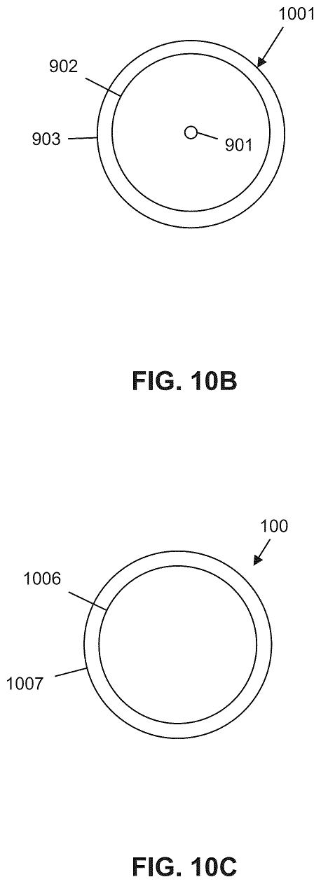

FIG. 10A shows a schematic for a MMC 501, in accordance with an embodiment of the present disclosure. The MMC 501 comprises one or more input ports 1001, a coupling region 1002, and a plurality of output ports 1003. At least one of input ports 1001 may be configured to receive light having an optical power and optical signal associated with it. The light may be provided by an optical fiber, such as the signal optical fiber described in relation to FIG. 4, which may have a core that primarily carries the optical signal and a cladding that primarily carries the optical power. This optical fiber may be coupled to the at least one input port 1001. The MMC 501 may be configured to separate the optical signal 1004, represented by a dash-dot line, from a substantial portion 1005 of the optical power of the light, represented by a dash-dot-dot line. The coupling region 1002 may be configured to achieve this separation by coupling each of the optical signal 1004 and the substantial portion 1005 of the optical power to respective output ports 1003, where each may be subsequently provided to respective optical fibers. In some embodiments, the MMC 501 may be formed as an all-glass DCF 900 coupled to a multimode fiber at the coupling region 1002. In these embodiments, light may be received by the all-glass DCF 900 and divided such that the optical signal 1004 continues in the glass core 901 of the all-glass DCF 900 and the substantial portion 1005 of the optical power is diverted into the multimode fiber.

FIG. 10B shows a cross-sectional schematic for an input port 1001 of a MMC 501, in accordance with an embodiment of the present disclosure. The input port 1001 may be configured as an all-glass DCF 900 having a glass core 901, a first glass cladding 902, a second glass cladding 903, and a jacket 904 (not shown).

FIG. 10C shows a cross-sectional schematic for an output port 1003 of a MMC 501, in accordance with an embodiment of the present disclosure. The output port 1003 may be configured to provide the substantial portion 1005 of the optical power of light received by the MMC 501. The output port 1003 may further be configured as a multimode fiber having a core 1006, a cladding 1007, and a jacket 904 (not shown).

In embodiments, when the coupler element 501 is a side coupler, the side coupler may be configured similarly to the MMC 501 shown in FIGS. 10A, 10B, and 10C. In the case of a side coupler, a side optical fiber may be fused to the signal optical fiber at a coupling region 1002. The side optical fiber may be tapered towards the coupling region 1002, so as to form a tapered fiber bundle. The side optical fiber may, for example, be a multimode fiber having a core and a cladding fused to the signal optical fiber.

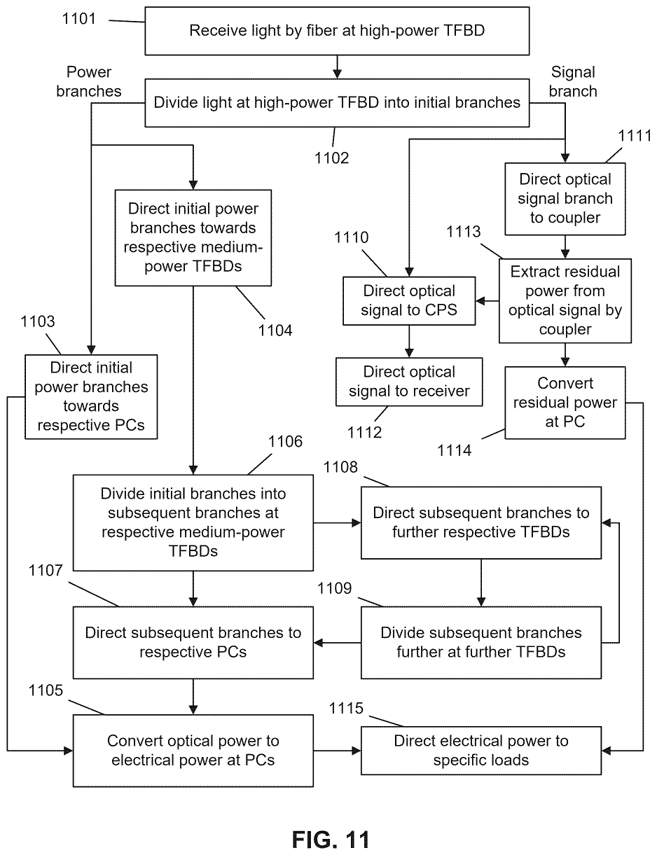

FIG. 11 shows a flowchart of a method for PwoF delivery, in accordance with an embodiment of the present disclosure. The method may be performed using, for example, the PwoF power receiver shown in FIG. 7. At action 1101, light may be received by a high-power TFBD 401 from a source optical fiber 102, such as an all-glass DCF or a TCF. The light may have associated with it an optical power and an optical signal. At action 1102, the light may be divided into a plurality of initial branches by the high-power TFBD 401 (i.e., a primary TFBD). The plurality of initial branches may include a plurality of power branches (i.e., primary branches of light), which may each receive a respective portion of the optical power, and a signal branch, which may receive the optical signal and a respective portion of the optical power.

Each power branch may be directed towards a respective PC 103, at action 1103, or towards a respective medium-power TFBD 402 (i.e., a secondary TFBD), at action 1104. When one of the power branches is directed towards a respective PC 103, the PC 103 may be used to convert the respective portion of optical power for that power branch to respective electrical power, at action 1105. When one of the power branches is directed towards a respective medium-power TFBD 402, that power branch may be divided, at action 1106, into a respective plurality of subsequent branches each having a respective portion of the optical power. Each subsequent branch may be directed towards a respective PC 103, at action 1107, or towards a further respective TFBD 201 (i.e., a tertiary TFBD), at action 1108. When one of the subsequent branches is directed towards a respective PC 103, the PC 103 may be used to convert the respective portion of optical power for that subsequent branch to respective electrical power, at action 1105. When one of the subsequent branches is directed towards a further respective TFBD 201, that subsequent branch may be divided, at action 1109, into a respective plurality of further subsequent branches each having a respective portion of the optical power. The further subsequent branches of light may be directed to respective PCs 103, at action 1107, and respective electrical power may be produced, at action 1105. Actions 1108 and 1109 may iterate for a cascade of TFBDs, such that quaternary and so forth branches of light may be created.

The signal branch may be directed to a CPS 202 for removal of residual optical power, at action 1110, or may be directed to a SC 501, at action 1111. When the signal branch is directed to the CPS 202, it may then be directed, at action 1112, to a signal receiver for detection of the optical signal. When the signal branch is directed to the SC 501, at least some of the respective portion of the optical power may be extracted by the SC 501, at action 1113, and converted to respective electrical power by a respective PC 103, at action 1114. The signal branch may then be directed to the CPS 202 for removal of residual optical power, at action 1110, and provided to the signal receiver, at action 1112, for detection of the optical signal.

At action 1115, any electrical power generated from each power branch and the signal branch may be directed to one or more electrical loads, such as RAUs 104. The electrical power may be directed according to the specific demand or requirements of each electrical load.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is

1. A method comprising:
receiving, at a primary tapered fiber bundle divider (TFBD), light from a source optical fiber, the light having associated thereto an optical power;
dividing, by the primary TFBD, the light into a plurality of primary branches of light, each primary branch of light having associated thereto a respective primary portion of the optical power;
dividing each primary branch of light into a respective plurality of secondary branches of light by a respective secondary TFBD, each secondary branch of light having associated thereto a respective secondary portion of the optical power depending from the respective primary portion of the optical power;
generating, from each secondary branch of light and in accordance with the respective secondary portion of the optical power, respective electrical power by a respective one or more power converters (PCs) of a plurality of PCs; and
delivering, for each secondary branch of light, the respective electrical power to one or more respective loads of a plurality of loads.

2. The method of claim 1 further comprising:
coupling, from the primary TFBD, each primary branch of light into a respective primary optical fiber;
and
sending each primary branch of light to the respective secondary TFBD by the respective primary optical fiber.

3. The method of claim 1 further comprising:
coupling each secondary branch of light, from the respective secondary TFBD, into a respective secondary optical fiber;
and
sending each secondary branch of light, by the respective secondary optical fiber, to one respective PC of the plurality of PCs.

4. The method of claim 1 wherein:
the light further has associated thereto an optical signal;
and
dividing, by the primary TFBD, the light into the plurality of primary branches of light includes:
dividing, by the primary TFBD, the light into the plurality of primary branches of light and a signal branch of light, the signal branch of light receiving the optical signal.

5. The method of claim 4 further comprising:
coupling, from the primary TFBD, the signal branch of light into a signal optical fiber;
and
sending, by the signal optical fiber, the signal branch of light to a signal receiver.

6. The method of claim 5 further comprising:
dividing, by a coupler element, the signal branch of light into a signal mode of light and a power mode of light, the signal mode of light receiving the optical signal, the power mode of light having associated thereto a respective portion of the optical power depending from the respective portion of the signal branch of light;
generating, from the power mode of light and in accordance with the respective portion of the optical power of the power mode of light, respective electrical power by a further PC;
and
detecting, by a receiver device, the optical signal of the signal mode of light.

7. The method of claim 1 wherein delivering, for each secondary branch of light, the respective electrical power to the one or more respective loads of the plurality of loads includes delivering, for at least one secondary branch of light, the respective electrical power to a remote antenna unit.

8. The method of claim 1 wherein receiving, at the primary TFBD, the light from the source optical fiber includes:
receiving, at the primary TFBD, the light from an all-glass double-clad fiber or a triple-clad fiber.

9. The method of claim 2 wherein coupling, from the primary TFBD, each primary branch of light into the respective primary optical fiber includes:
coupling, from the primary TFBD, each primary branch of light into a respective all-glass double-clad fiber or a respective triple-clad fiber.

10. The method of claim 5 wherein coupling, from the primary TFBD, the signal branch of light into the signal optical fiber includes:
coupling, from the primary TFBD, the signal branch of light into an all-glass double-clad fiber or a triple-clad fiber.

11. The method of claim 1 wherein delivering, for each secondary branch of light, the respective electrical power to the one or more respective loads of the plurality of loads includes:
delivering, for each secondary branch of light, the respective electrical power to the one or more respective loads of the plurality of loads in accordance with a respective power demand of the respective load.

12. A power-over-fiber (PwoF) system comprising:
a primary tapered fiber bundle divider (TFBD) having a respective input port configured to receive light having associated thereto an optical power, the primary TFBD configured to divide the light into a plurality of primary branches of light each having associated thereto a respective primary portion of the optical power, the primary TFBD further having a respective plurality of output ports each configured to provide a respective primary branch of light from among the plurality of primary branches of light;
a plurality of secondary TFBDs each having a respective input port coupled a respective output port of the plurality of output ports of the primary TFBD and configured to receive therefrom the respective primary branch of light, each secondary TFBD configured to divide the respective primary branch of light into a respective plurality of secondary branches of light each having associated thereto a respective secondary portion of the optical power depending from the respective primary portion of the optical power, each secondary TFBD further having a respective plurality of output ports each configured to provide a respective secondary branch of light from among the plurality of secondary branches of light of the respective secondary TFBD;
and
a plurality of sets of power converters (PCs), each set of PCs including one or more PCs and being coupled to one respective output port of one respective secondary TFBD of the plurality of secondary TFBDs, each PC configured to generate, from the respective secondary branch of light of the respective output port of the respective secondary TFBD and in accordance with the respective secondary portion of the optical power, respective electrical power.

13. The PwoF system of claim 12 wherein:
the light further has associated thereto an optical signal;
and
the primary TFBD is further configured to divide the light into the plurality of primary branches of light and a signal branch of light, the signal branch of light receiving the optical signal.

14. The PwoF system of claim 13 wherein:
the primary TFBD further has a primary TFBD signal port configured to provide the signal branch of light;
and
the PwoF system further comprises:
a coupler element having a respective input port coupled to the primary TFBD signal port of the primary TFBD and configured to receive the signal branch of light therefrom, the coupler element configured to divide the signal branch of light into a signal mode of light and a power mode of light, the signal mode of light receiving the optical signal, the power mode of light having associated thereto a respective portion of the optical power depending from the respective portion of the signal branch of light, the coupler element further having a coupler power output port and a coupler signal output port, the coupler power output port configured to provide the power mode of light, the coupler signal output port configured to provide the signal mode of light;
a further PC coupled to the coupler power output port and configured to receive the power mode of light therefrom, the further PC further configured to generate, from the power mode of light and in accordance with the respective portion of the optical power, respective electrical power;
and
a receiver device coupled to the coupler signal output port and configured to receive the signal mode of light therefrom.

15. The PwoF system of claim 12 wherein each PC of the plurality of sets of PCs is coupled to a respective one or more loads of a plurality of loads in accordance with a respective power demand of each of the respective one or more loads.

16. A method comprising:
receiving, at a tapered fiber bundle divider (TFBD), light from a source optical fiber, the light having associated thereto an optical power, the source optical fiber being one of an all-glass double-clad fiber and a triple-clad fiber;
dividing, by the TFBD, the light into a plurality of branches of light, each branch of light having associated thereto a respective portion of the optical power;
generating, from each branch of light and in accordance with the respective portion of the optical power, respective electrical power by one respective power converter (PC) of a plurality of PCs;
and
delivering, for each branch of light, the respective electrical power to one or more respective loads of a plurality of loads.

17. The method of claim 16 further comprising:
coupling, from the TFBD, each branch of light into a respective branch optical fiber, each branch optical fiber being an all-glass double-clad fiber or a triple-clad fiber;
and
sending each branch of light, by the respective branch optical fiber, to the one respective PC of the plurality of PCs.

18. The method of claim 16 wherein:
the light further has associated thereto an optical signal;
the source optical fiber has a core, a first glass cladding, and a second glass cladding;
receiving, at the tapered fiber bundle divider (TFBD), the light from the source optical fiber includes:
receiving, at the TFBD:
the optical signal of the light by the core of the source optical fiber,
and
the optical power of the light by the first glass cladding of the source optical fiber;
and
dividing, by the TFBD, the light into the plurality of branches of light includes:
dividing, by the TFBD the light into the plurality of branches of light and a signal branch of light.

19. The method of claim 18 further comprising:
coupling, from the TFBD, the signal branch of light into a signal optical fiber, the signal optical fiber being an all-glass double-clad fiber or a triple-clad fiber.

20. The method of claim 16 wherein delivering, for each branch of light, the respective electrical power to the one or more respective loads of the plurality of loads includes:
delivering, for each branch of light, the respective electrical power to the one or more respective loads of the plurality of loads in accordance with a respective power demand of the respective load.
